(19) United States
(12) Patent Application Publication
(10) Pub. No.: US 2006/0132851 A1
(43) Pub. Date: Jun. 22, 2006

(54) Slide type portable device having an optical zoom assembly

(75) Inventor: Young S. Kim, Los Altos, CA (US)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/265,857

(22) Filed: Nov. 3, 2005

Related U.S. Application Data
(60) Provisional application No. 60/639,034, filed on Dec. 21, 2004.

(30) Foreign Application Priority Data
Jun. 20, 2005 (KR) 53251-2005

(51) Int. Cl. H04N 1/23

(52) U.S. Cl. 358/296

(57) ABSTRACT

A slide type portable device having an optical zoom lens assembly is disclosed. The portable device includes a body; a slider opposed to the body and opening/closing a predetermined area of a top surface of the body; and an optical lens assembly providing a first camera lens view path passing through the top surface the body and a second camera lens view path passing through a bottom surface of the body according to movement of the slider, the optical lens assembly being embedded in the body.

### PRIORITY

This application claims the benefit under 35 U.S.C. 119(a) of an application entitled “CAMERA PHONE WITH INTERNAL ZOOM” filed with the United States Patent and Trademark Office on Dec. 21, 2004 and assigned U.S. Ser. No. 60/639,034, and an application entitled “SLIDE TYPE PORTABLE DEVICE HAVING OPTICAL ZOOM ASSEMBLY” filed with the Korean Intellectual Property Office on Jun. 20, 2005 and assigned Serial No. 2005-53251, the contents of each of which are incorporated herein by reference.

### BACKGROUND OF THE INVENTION

1. Field of the Invention

The present invention relates to a portable device including a cellular phone, a PDA (Personal Digital Assistant), an HHP (Hand Held Phone), a DMB (Digital Multimedia Broadcasting) phone, a camera phone, etc., and more particularly to a slide type portable device having an optical zoom lens assembly.

2. Description of the Related Art

In general, “portable communication device” refers to an electronic device that a user can carry to perform wireless communication with a desired partner. To facilitate portability, designs of such portable communication devices tend not only to be compact, slim, and light, but are also moving toward providing multimedia availability, having a wider variety of functions. In particular, future portable communication devices are expected to incorporate greater multi-functionality and be capable of multi-purpose utilization, as well as being modified to be suitable for various multimedia or Internet environments.

Portable communication devices may be classified into various categories according to their appearance, such as a bar-type portable communication device, a flip-type portable communication device, and a folder-type portable communication device. A bar-type portable communication device is a device having a single bar-shaped housing. A flip-type portable communication device is to a device in which a flip is rotatably mounted to a housing by a hinge unit. A folder-type communication device refers to manner in which a folder is rotatably connected to a single bar-type housing by a hinge unit.

Portable communication devices may also be classified as a necklace type portable communication device and a bracelet type portable communication device according to the wearing position or the way in which users put on the portable communication devices. The necklace type portable communication device refers to a terminal which is worn around the neck of a user by a string. Further, the bracelet type portable communication device refers to a portable terminal worn around a wrist of a user.

In addition, portable communication devices may be classified as a rotation-type portable communication device and a slide-type communication device according to the manner of opening and closing the portable communication device. The rotation-type portable communication device refers to a manner in which two housings are rotatably connected, while being opposed to each other. The slide-type communication device refers to a manner in which two housings are slid with respect to each other in the lengthwise direction of the device. These variously classified portable communication devices can be easily understood by those skilled in the art.

Conventional portable communication devices now tend to transmit data at a high speed in addition to performing the basic voice communication function. In other words, according to an increase in consumer demand, portable communication devices now provide a service using a wireless communication technology capable of transmitting data at high speed.

Recent portable communication devices also tend to be equipped with a camera lens to obtain video signals for transmission. In other words, current portable communication devices have an external or embedded camera lens module which enables users to perform video communication with desired partners or to photograph desired subjects.

However, while the conventional portable device has no problem in voice communication, it may require two camera lens modules for taking a photograph of a subject using a camera lens or for taking a video while in videophone mode. Namely, a user photographs a subject in a subject photograph mode, while watching a display and focusing an X-point on the subject. Further, in the videophone mode, a user can talk with a partner, watching both a camera lens and the display. Therefore, since the camera lens modules should be disposed in a direction towards the upper surface of the body and in a direction towards the bottom surface of the body, respectively, two camera lens modules are required and the camera lens view paths are needed to be provided independently, which makes the overall size of the body bigger. Especially, in order for the camera lens module to include an optical zoom function, a focusing distance of over a predetermined distance is required, thereby making the overall size of the body even bigger.

### SUMMARY OF THE INVENTION

Accordingly, the present invention has been made to solve the above-mentioned problems occurring in the prior art, and an object of the present invention is to provide a miniaturized portable device having an optical zoom lens assembly.

Another object of the present invention is to provide a portable device which can provide camera lens view paths on the upper and lower surfaces respectively even with one optical lens system, thereby allowing a user to conveniently photograph a subject, while advantageously miniaturizing the device.

Another object of the present invention is to provide a portable device which can select camera lens view paths with a simple sliding operation so that a user can conveniently use a camera mode.

Another object of the present invention is to provide a portable device which can be advantageously miniaturized even with an optical zoom lens system requiring a focus distance and can provide two camera lens view paths.

In order to accomplish these objects, there is provided a portable device including a body; a slider opposed to the body and opening/closing a predetermined area of a top surface of the body; and an optical lens assembly providing a first camera lens view path passing the top surface of the body or a second camera lens view path passing a bottom surface of the body according to movement of the slider, the optical lens assembly being embedded in the body.

### BRIEF DESCRIPTION OF THE DRAWINGS

The above and other objects, features, and advantages of the present invention will be more apparent from the following detailed description taken in conjunction with the accompanying drawings, in which:

FIG. 1 is a perspective view showing a slide type portable device according to the present invention;

FIG. 2 is a bottom view of the slide type portable device of FIG. 1;

FIG. 3 is a perspective view of the slide type portable device of FIG. 1 with a slider thereof slid in one direction thereof;

FIG. 4 is a perspective view of the slide type portable device of FIG. 1 with the slider thereof slid in the other direction thereof;

FIG. 5 is a cross-sectional view taken along line X-X′ of FIG. 1;

FIG. 6 is a cross-sectional view of the slide type portable device of FIG. 1 with the slider thereof moved in the other direction thereof according to FIG. 5; and

FIG. 7 is a perspective view showing a link mechanism employed in the slider type portable device of FIG. 1.

### DETAILED DESCRIPTION OF THE PREFERRED EMBODIMENT

Hereinafter, a preferred embodiment of the present invention will be described with reference to the accompanying drawings. In the following description of the present invention, a detailed description of known functions and configurations incorporated herein is omitted to avoid obscuring the subject matter of the present invention.

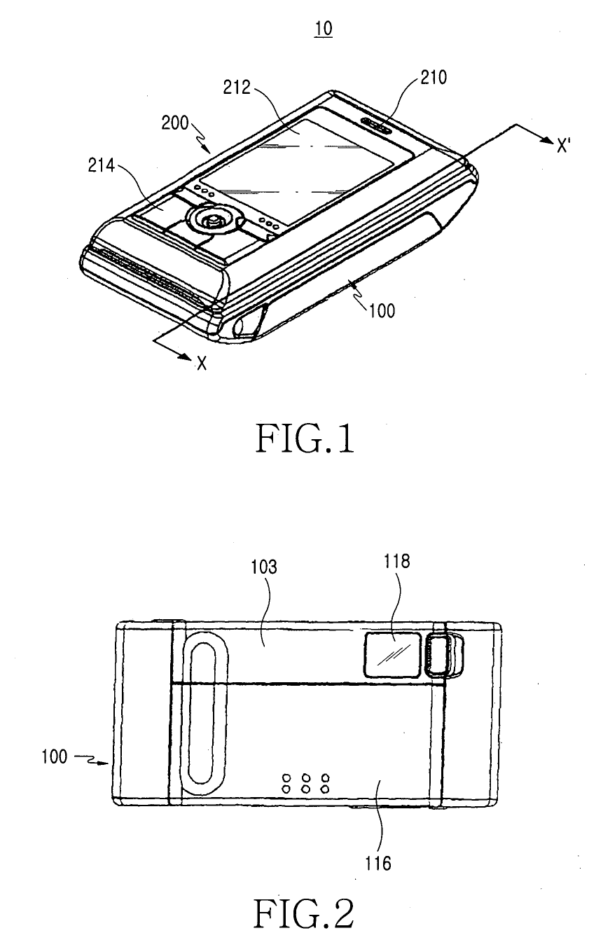

As shown in FIGS. 1, 3, and 4, a portable device 10 according to the present invention is a bi-directional slide type portable device. The bi-directional slide type portable device 10 includes a body 100, a slider 200 opening/closing a predetermined area of the top surface of the body 100, opposite to the body 100, and an optical zoom lens assembly provided in the body 100 and providing camera lens view paths towards the top and bottom surfaces of the body 100 respectively. The optical zoom lens assembly will be described later.

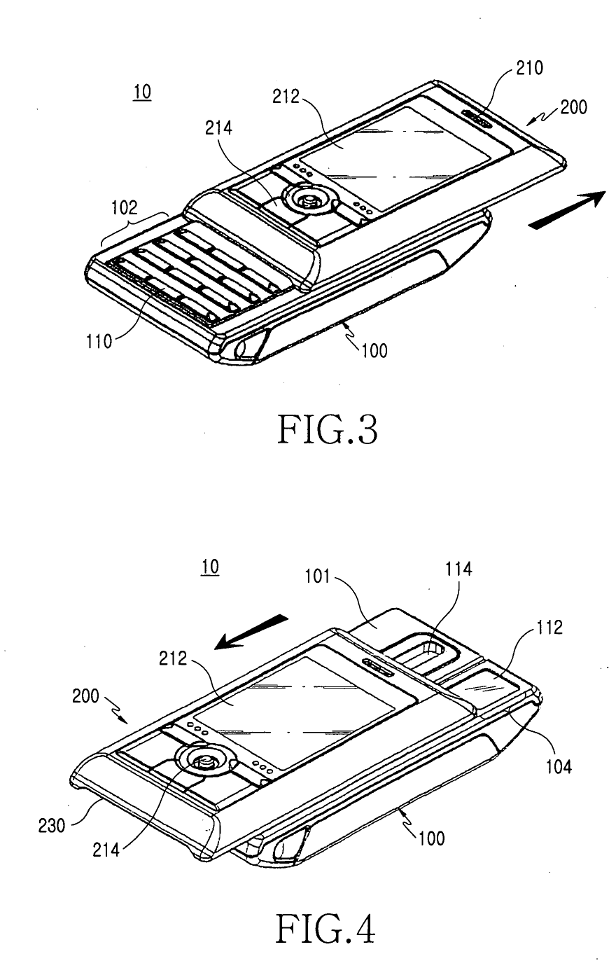

Referring to FIG. 3, the slider 200 can slide in one direction of the body 100 to open/close a first area 102 of the top surface of the body 100, and as shown in FIG. 4, can slide in the other direction of the body 100 to open/close a second area 104 of the top surface of the body 100. The first and second areas are located on opposite sides to each other. FIG. 3 shows the slide type portable device with the slider 200 thereof slid in one direction of the body 100, and FIG. 4 shows the slide type portable device with the slider 200 thereof slid in the other direction of the body 100. The slider 200 is moved linearly in the lengthwise direction of the body 100 when it slides.

As shown in FIG. 1, on the top surface of the slider are sequentially disposed a speaker unit 210, a display 212, and a first key pad 214 on which a plurality of first keys are arranged. The first keys includes function and control keys. The speaker unit 210 is located adjacent to the display 212, and the display 212 is located adjacent to the first key pad 214.

As shown in FIG. 2, on the bottom surface 103 of the body 100 are disposed a battery pack 116 and a second camera window 118. The battery pack 116 is attached and detached in a direction perpendicular to the slide direction of the slider 200. Namely, the attaching and detaching direction of the battery pack 116 is one in which the battery pack 116 is attached and detached to and from the side surface of the body 100. The battery pack 116 includes a battery cell (not shown) to supply electric power.

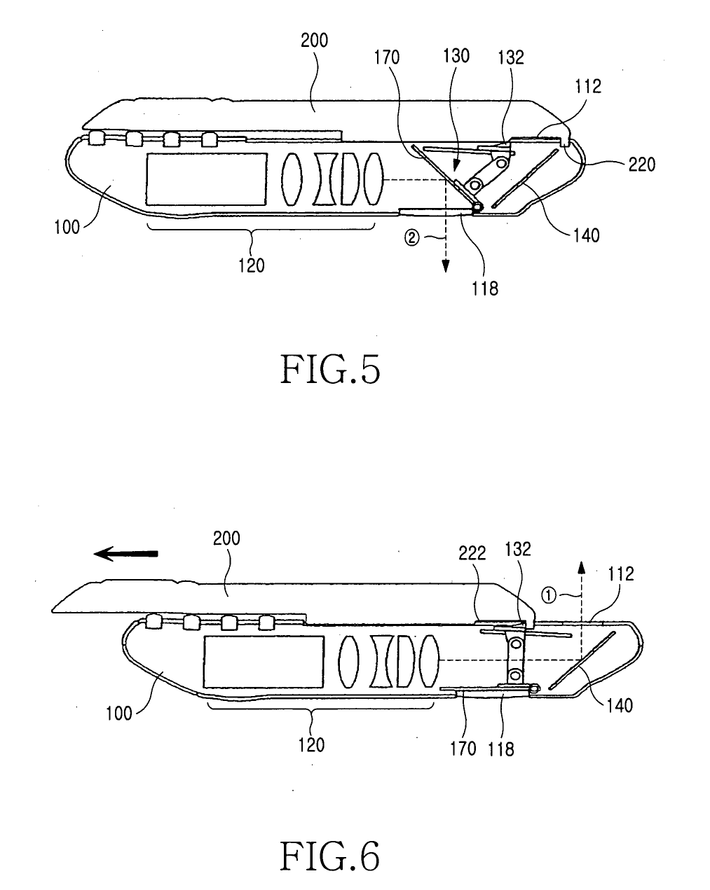

As shown in FIGS. 3 and 4, a second key pad 110 on which a plurality of second keys are arranged is disposed in the first area 102 of the body 100, and a first camera window 112 is disposed in the second area 104 of the body 100. Reference numeral 114 of FIG. 4 indicates a guide slot. The guide slot 114 determines the slide direction of the slider 200. As shown in FIG. 5, the first and second camera windows 112 and 118 are parallel to each other and face each other on the top and bottom surfaces 101 and 103 of the body 100.

In FIG. 4, a receiving recess 230 recessed to a predetermined depth is provided on the end of the bottom surface of the slider 200. The receiving recess 230 is formed to prevent interference with the keys of the second key pad 110 according to movement of the slider 200.

As shown in FIGS. 5 and 6, the optical zoom lens assembly is mounted into the body 100. The optical zoom lens assembly provides first and second camera lens view paths 1 and 2 passing the top surface 101 of the body 100 (FIG. 6) or passing the bottom surface 103 of the body 100 (FIG. 5) according to movement of the slider 200.

The optical zoom lens assembly includes a zoom lens system 120, a link mechanism 130 disposed in front of the zoom lens system 120 and moved dependently on the movement of the slider 200, and a reflection unit selectively providing the first and second lens view paths 1 and 2 of the zoom lens system 120 according to movement of the link mechanism 130. In the case in which the slider 200 is completely slid from the body 100, the first camera lens view 1 is provided (FIG. 6), and in the case in which the slider 200 is completely closed, the second camera lens view path 2 is provided (FIG. 5). The dotted arrow of FIG. 6 indicates the state in which the first camera view path 1 is provided, and the dotted arrow of FIG. 5 indicates the state in which the second camera view path 2 is provided.

The reflection device includes a fixed mirror 140 separated from the link mechanism to provide the first camera lens view path 1 and a movable mirror 170 integrally provided in the link mechanism 130 in a hinged manner and rotated according to movement of the slider 200 to provide the second camera lens view path 2.

The fixed mirror 140 is inclined from the first camera window 112 and provides the first camera lens view path 1. The movable mirror 170 is inclined from the second camera window 118 and provides the second camera lens view path 2. As a result, the first camera lens view path 1 turns towards the direction perpendicular to the top surface 101 of the body 100, and the second camera lens view path 2 turns towards the direction perpendicular to the bottom surface 103 of the body 100. The direction of the first camera lens view path 1 is converted by about ninety degrees through the fixed mirror 140, and the direction of the second camera lens view path 2 is converted by about ninety degrees through the movable mirror 170.

As shown in FIGS. 5 and 6, the portable device further includes a restricting means by which the link mechanism 130 is dependent on movement of the slider. The dependence of the link mechanism 130 rotates the movable mirror 170 to provide the first camera lens view path 1, or provides the second camera lens view path 2. Such an operation is determined by the selection of a user. The restricting means includes first catching bosses 220 and 222 formed on the bottom surface of the slider 200 and a second catching boss 132 formed at the upper end of the link mechanism 130 and moved together with the first catching bosses 220 and 222, dependent on movement of the slider 200.

The first catching bosses 220 and 222 protrude at predetermined positions of the bottom surface of the slider 200. One first catching boss 220 is provided to correspond to the second catching boss 132 when the slider 200 is moved in the other direction of the slider 200 (FIG. 6), and the other first catching boss 222 is provided to correspond to the second catching boss 132 when the slider 200 is continuously moved to the original position of the slider 200 (FIG. 5).

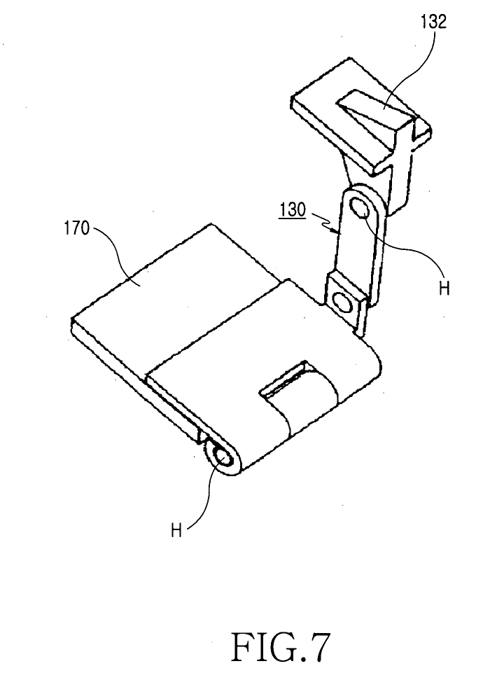

As shown in FIG. 7, showing the link mechanism 130, several links are rotatably connected to each other by hinges H. For convenience sake, the explanation of a spring provided in the link mechanism 130 is omitted.

The present invention can advantageously miniaturize the portable device, and can maximize the convenience during the use of the portable device using two camera lens view paths with a simple operation. While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A portable device comprising:
a body;
a slider opposed to the body and opening/closing a predetermined area of a top surface of the body; and
an optical lens assembly providing a first camera lens view path passing through the top surface of the body and a second camera lens view path passing through a bottom surface of the body according to movement of the slider, the optical lens assembly being embedded in the body.

2. A portable device according to claim 1, wherein the slider slides in a first direction of the body to open/close a first area of the top surface of the body and slides in a second direction of the body to open/close a second area of the top surface of the body, the first and second areas being located on opposite sides with respect to each other, the first direction being opposite to the second direction.

3. A portable device according to claim 2, wherein a first camera window for the first camera lens view path is disposed in the second area and a second camera window for the second camera lens view path is disposed at a predetermined position of the bottom surface of the body.

4. A portable device according to claim 3, wherein the first and second camera windows are parallel to each other.

5. A portable device according to claim 2, wherein a first key pad on which a plurality of keys are arranged is disposed in the first area.

6. A portable device according to claim 3, wherein the optical lens assembly is an optical zoom lens assembly which comprises:
a zoom lens system;
a link mechanism disposed at a front end of the zoom lens system that moves dependently on the movement of the slider; and
a reflection unit selectively providing the first and second camera lens view paths of the optical lens assembly according to movement of the link mechanism.

7. A portable device according to claim 6, wherein the reflection unit comprises:
a fixed mirror separated from the link mechanism on the rear end of the link mechanism to provide the first camera lens view path; and
a movable mirror integrally provided in the link mechanism in a hinged manner and rotated according to movement of the slider to provide the second camera lens view path.

8. A portable device according to claim 7, wherein:
the fixed mirror is inclined from the first camera window to provide the first camera lens view path; and
the movable mirror is inclined from the second camera window to provide the second camera lens view path.

9. A portable device according to claim 6, further comprising a restricting means by which the link mechanism is dependent on movement of the slider.

10. A portable device according to claim 9, wherein the restricting means comprises:
at least one first catching boss formed on a bottom surface of the slider; and
a second catching boss formed at an upper end of the link mechanism and movable together with the first catching boss, the second catching boss being dependent on movement of the slider.

11. A portable device according to claim 1, wherein, in a case in which the slider is completely slid from the body, the first camera lens view is provided, and in the case in which the slider is completely closed, the second camera lens view path is provided.

12. A portable device according to claim 2, wherein a battery pack attachable and detachable in a direction perpendicular to a slide direction of the slider is disposed on the bottom surface of the body.
